(19) United States
(12) Patent Application Publication
(10) Pub. No.: US 2014/0245093 A1
(43) Pub. Date: Aug. 28, 2014

(54) MASTER BOOT RECORD PROTECTION IN A SOLID STATE DRIVE

(71) Applicant: LSI CORPORATION, San Jose, CA (US)

(72) Inventors: Li Zhao Ma, Shanghai (CN); Peng Xu, Shanghai (CN); Ning Zhao, Shanghai (CN); De Ling Li, Shanghai (CN); Zhao Cui, Shanghai (CN)

(73) Assignee: LSI CORPORATION, San Jose, CA (US)

(21) Appl. No.: 13/792,980

(22) Filed: Mar. 11, 2013

(30) Foreign Application Priority Data
Feb. 25, 2013 (CN) 201310057945.2

(51) Int. Cl. G06F 11/08

(52) U.S. Cl. CPC G06F 11/08
USPC 714/747

(57) ABSTRACT

A method for protecting a master boot record in a solid state drive, comprising the steps of (A) receiving a plurality of input/output requests from a host device, (B) determining whether one or more of the input/output requests is read/written to a first of a plurality of logical block addresses of the solid state drive and (C) writing an entry to a table for each of the input/output requests read/written to the first of the logical block addresses. The table (i) is separate from the first of the logical block addresses and (ii) is used to recover errors in the first of the logical block addresses.

### FIELD OF THE INVENTION

The present invention relates to storage devices generally and, more particularly, to a method and/or apparatus for providing master boot record protection in a solid state drive.

### BACKGROUND

A conventional bootable drive contains a master boot record (MBR). A MBR is located in the first Logical Block Address (LBA0) of a drive. A MBR contains critical information about the drive, including the partition table. Corruption of an MBR, caused by either media error or unintended overwrite of the first LBA, will usually lead to loss of all data on the drive.

### SUMMARY

The present invention concerns a method for protecting a master boot record in a solid state drive, comprising the steps of (A) receiving a plurality of input/output requests from a host device, (B) determining whether one or more of the input/output requests is read/written to a first of a plurality of logical block addresses of the solid state drive and (C) writing an entry to a table for each of the input/output requests read/written to the first of the logical block addresses. The table (i) is separate from the first of the logical block addresses and (ii) is used to recover errors in the first of the logical block addresses.

### BRIEF DESCRIPTION OF THE DRAWINGS

Embodiments of the invention will be apparent from the following detailed description and the appended claims and drawings in which:

FIG. 1 is a diagram illustrating a context of an embodiment of the invention;

FIG. 2 is a flow diagram for processing a host write;

FIG. 3 is a flow diagram for processing a host read;

FIG. 4 is a flow diagram for processing an unintended overwrite; and

FIG. 5 is a flow diagram for processing a media failure.

### DETAILED DESCRIPTION OF THE PREFERRED EMBODIMENTS

Embodiments of the invention include providing master boot record protection that may (i) be implemented in a solid state drive (SSD), (ii) provide a record option for reads and writes to the MBR, (iii) allow recovery of a corrupted master boot record and/or (v) be easy to implement.

Embodiments of the invention use log data to protect a master boot record (MBR) in a bootable device, such as a solid state drive (SSD). The MBR is typically the first logical block address (LBA) of an SSD. The MBR usually contains data relating to a file system, such as the partition table. If the MBR is corrupted, or deleted by mistake, then the SSD will not be readable and, therefore, not bootable. One embodiment uses stored log data to restore the last content of the MBR, and/or restores the partition table.

To protect the MBR against various sources of corruption and/or to improve the overall stability of the drive, a process is used to enhance the safety of the MBR and/or restore data in case of corruption. In one example, log data may be used to save a copy of the MBR to an additional portion of the drive. If a user wants to restore the MBR, a command (e.g., using a special command code format) may be sent to the drive. The drive will then return a previous copy of the MBR. In one example, when writing data to the LBA0 (e.g., the first LBA of drive), the LBA0 may be written to a log area. Each subsequent write to the log area may write to a different portion of the log pages. One or more previous versions of the LBA0 (e.g., an old LBA) will be stored. When the host wants to restore the old LBA0, the old LBA0 may be retrieved and/or returned to the host. In one implementation, the log area may store a redundant copy to protect against a partial media failure.

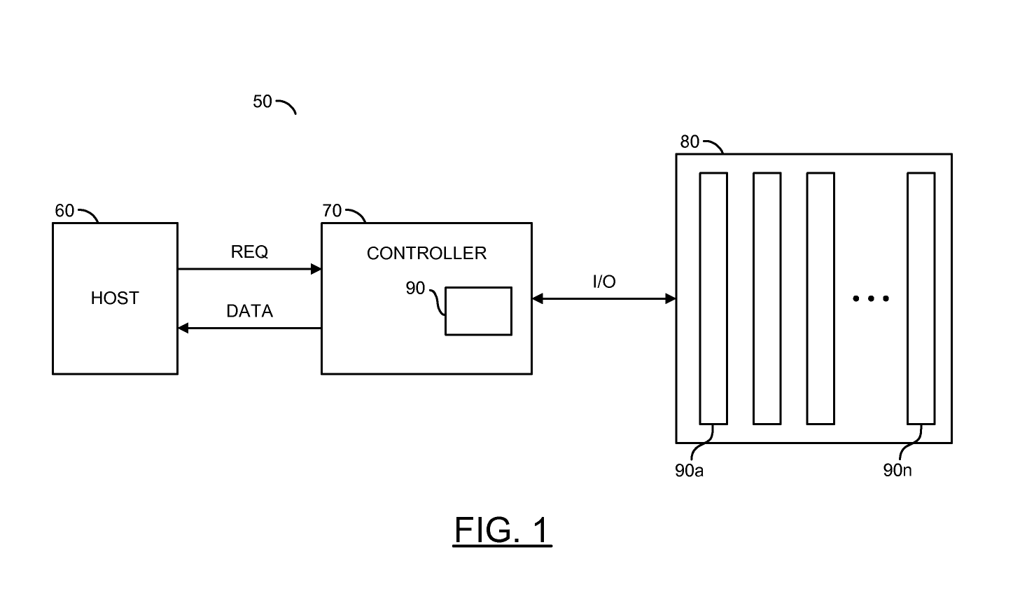

Referring to FIG. 1, a block diagram of an example apparatus 50 is shown. The apparatus 50 generally comprises a block (or circuit) 60, a block (or circuit) 70 and a block (or circuit) 80. The circuit 70 may include a circuit 90. The circuit 90 may be a memory configured to store computer instructions (or firmware). The instructions, when executed, may perform a number of steps.

A signal (e.g., REQ) may be generated by the circuit 60. The signal REQ may be received by the circuit 70. The signal REQ may be a request signal that may be used to access data from the circuit 80. A signal (e.g., I/O) may be generated by the circuit 70 to be presented to/from the circuit 80. The signal REQ may include one or more address bits. A signal (e.g., DATA) may be one or more data portions received by the circuit 80.

The circuit 60 is shown implemented as a host circuit. The circuit 70 reads and writes data to and from the circuit 80. The circuit 80 is generally implemented as a nonvolatile memory circuit. The circuit 80 may include a number of modules 90a-90n.

The modules 90a-90n may be implemented as NAND flash chips. In some embodiments, the circuit 80 may be a NAND flash device. In other embodiments, the circuit 70 and/or the circuit 80 may be implemented as all or a portion of a solid state drive having one or more nonvolatile devices. The circuit 80 is generally operational to store data in a nonvolatile condition. When data is read from the circuit 80, the circuit 70 may access a set of data (e.g., multiple bits) identified in the signal REQ.

In some embodiments, the circuit 80 may be implemented as a single-level cell (e.g., SLC) type circuit. An SLC type circuit generally stores a single bit per memory cell (e.g., a logical 0 or 1). In other embodiments, the circuit 80 may be implemented as a multi-level cell (e.g., MLC) type circuit. An MLC type circuit is generally capable of storing multiple (e.g., two) bits per memory cell (e.g., logical 00, 01, 10 or 11). In still other embodiments, the circuit 80 may implement a triple-level cell (e.g., TLC) type circuit. A TLC circuit may be able to store multiple (e.g., three) bits per memory cell (e.g., a logical 000, 001, 010, 011, 100, 101, 110 or 111).

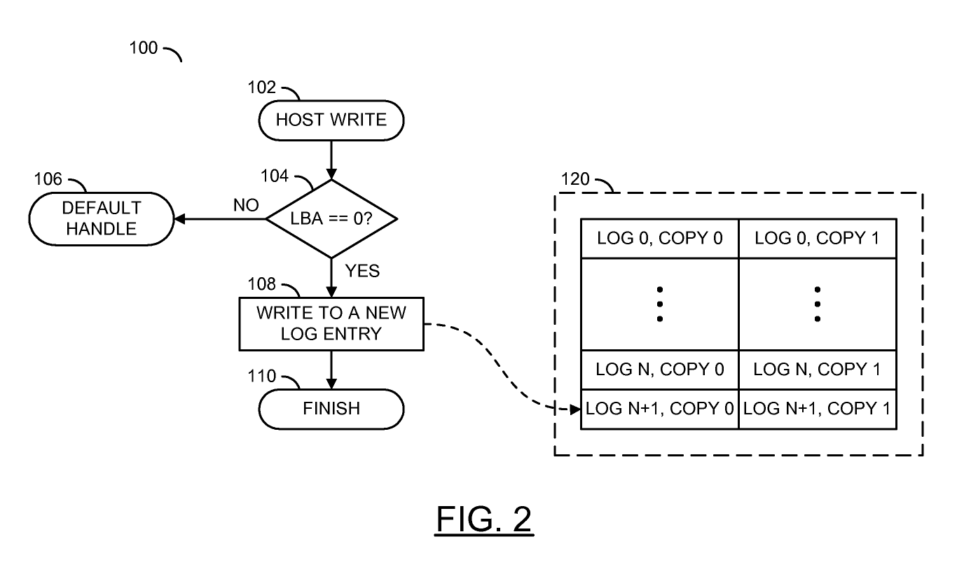

Referring to FIG. 2, a diagram of a method 100 is shown. The method 100 may be used to process host write operations. Instructions to execute the steps of the method 100 may be stored in the memory 90. The method 100 generally comprises a step (or state) 102, a decision step (or state) 104, a step (or state) 106, a step (or state) 108, and a step (or state) 110. The state 102 may initiate a host write operation. The decision state 104 may determine if the LBA that the host 60 writes to is equal to zero. If not, the method 100 moves to the state 106, which implements a default handling operation. If the LBA is equal to zero, the method 100 moves to the state 108. The state 108 writes a new log entry to a table 120. Next, the method 100 moves to the state 110, which completes the write operation from the host 60.

The table 120 may be implemented as a log table. The log table 120 may track data read/write operations to the first LBA to protect the MBR. The protection of the MBR is important when data is read from or written to the MBR. At least one version of the SATA specification defines a General Purpose Logging (GPL) feature set. Such a feature set allows a log area in the circuit 80 to be set aside from routine input/output requests. Device Vendor Specific Logs (e.g., Log Addresses A0h-DFh) may be used to store the MBR (e.g., LBA0). An example of such a GPL feature set may be found in Information technology-AT Attachment 8—ATA/ATAPI Command Set (ATA8-ACS), section 4.10, A.1, A.2 and A.6, the appropriate portions of which are incorporated by reference.

In one embodiment, the table 120 may use such Device Vendor Specific logs over a sample range (e.g., from Log Address A0h to Log Address Dfh). The Log Address A0h and A1h may be used to store the LBA0. In one example, log addresses may be defined to each have 16 pages, allowing 16 copies of the LBA0 to be stored. However, the particular number of copies of the LBA0 stored may be varied to meet the design criteria of a particular implementation.

The method 100 may be used when a write request is received from the host 60. The decision state 104 may determine if the host 60 requests to write to the LBA0. If the host 60 requests to write to the LBA0, the data is also written to the log area of the table 120. In one example, a redundant copy may be stored (e.g., shown as Copy 0 and Copy 1). The method 100 finds the last log page in the log address (e.g., A0h and A1h). The method 100 writes to the next log address with dual copies (e.g., one copy writes to log address A0h, one writes to log address A1h, etc.). In general, the table 120 may be stored in the flash memory 80.

The log address is shown as a fix-length area. When a device has written to the last log page, there is no space left. To address this problem, the device may store a flag to indicate which log page is the last one, and which log page is the first one. When the device writes to the last log page, a “last page” flag is 15, and “first page” flag is 0. The next time the host 60 writes to the first log page, the “last page” flag is 0, and “first page” flag is 1. In such an implementation, the device uses log pages in a circular buffer manner.

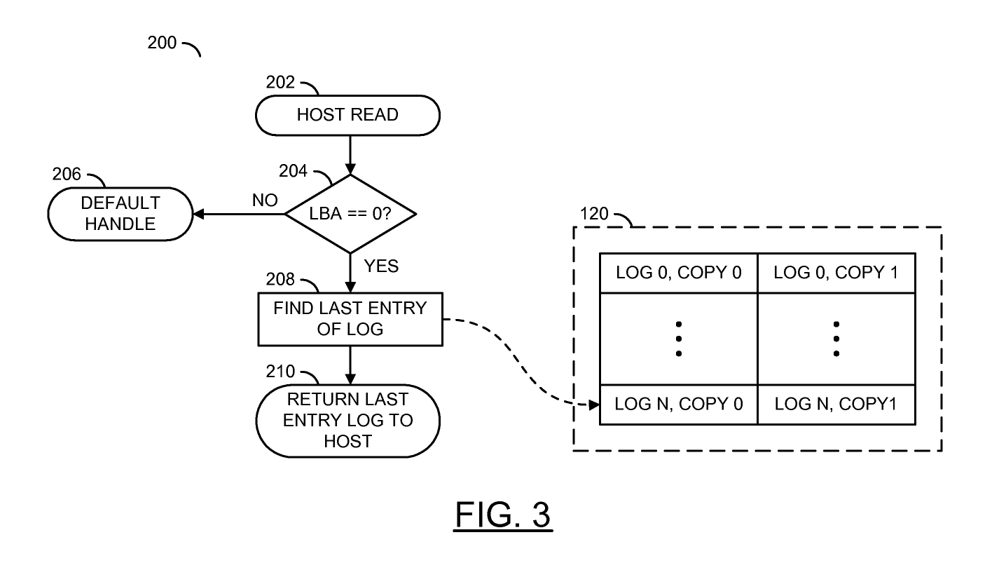

Referring to FIG. 3, a diagram of a method 200 is shown.

The method 200 may be used to process a host read operation. Instructions to execute the steps of the method 200 may be stored in the memory 90. The method 200 generally comprises a step (or state) 202, a decision step (or state) 204, a step (or state) 206, a step (or state) 208, a step (or state) 210. The state 202 may implement a host read operation. The decision state 204 may determine if the logical block address of the host read is equal to zero. If not, the method 200 moves to the state 206 to perform a handling operation. If the logical block address is equal to zero, the method 200 moves to the step 208, which performs an update to the table 120. Next, the method 200 moves to the state 210 which returns a log to the host 60.

The method 200 may be used when the host 60 reads data from the memory 80. The state 204 determines if the host 60 requests a read from the LBA0. If the host 60 requests a read from the LBA0, the step 208 finds the last page entry of the log. The last entry of the log is returned to the host 60.

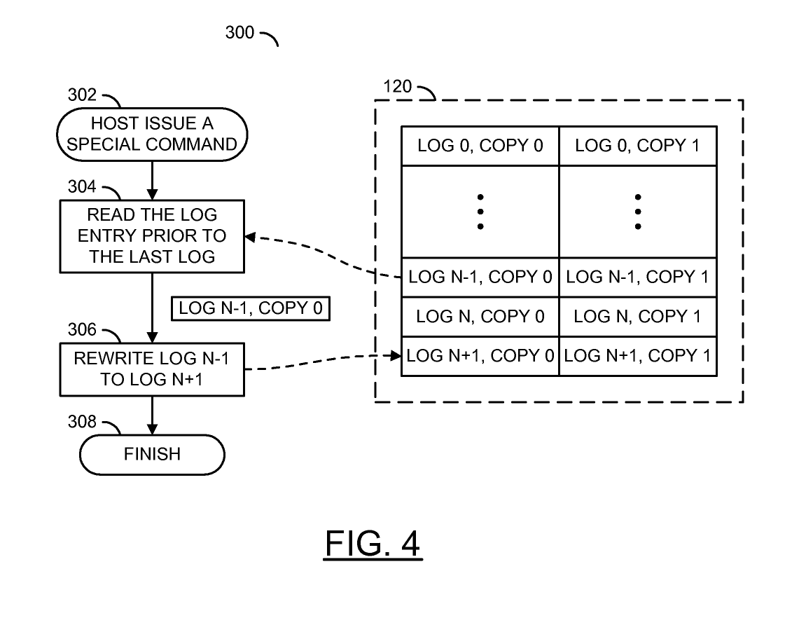

Referring to FIG. 4, a diagram of a method (or process) 300 is shown. The method 300 may be used to process unintended overwrite operations. Instructions to execute the steps of the method 300 may be stored in the memory 90. The method 300 generally comprises a step (or state) 302, a step (or state) 304, a step (or state) 306, and a step (or state) 308. The state 302 may issue a special command. Next, the state 304 may read the log entry saved prior to the last update (e.g., Log N−1). Next, the state 306 may rewrite the log entries from Log N−1 to Log N+1. Next, the state 308 finishes (or ends) the method 300. The method 300 may implement a sequence to restore a previous log entry.

The process 300 may be used when a user corrupts the MBR. For example, a user may write to the MBR with wrong (or otherwise unintended) data. The process 300 may restore the old data of MBR from the log data table 120. In one example, a command code F7h may be used as a special command for read “old” LBA0 to HOST. In the embodiment described, the host 60 issues a restore command (e.g., the command code F7h). The restore command code means “restore last MBR”. The last written log entry (Log N) is determined. A read of the LBA0 prior to the last entry (e.g., Log N−1) is read. The Log N−1 represents the old MBR of the drive. The data is rewritten to Log N−1 and to Log N+1 in both log addresses A0h and A1h. The Log N+1 will become the last log page in the log address. The Log N−1 is then returned to the host 60. The next time host 60 reads the LBA0, the host 60 will actually read Log N−1, which is the old LBA0.

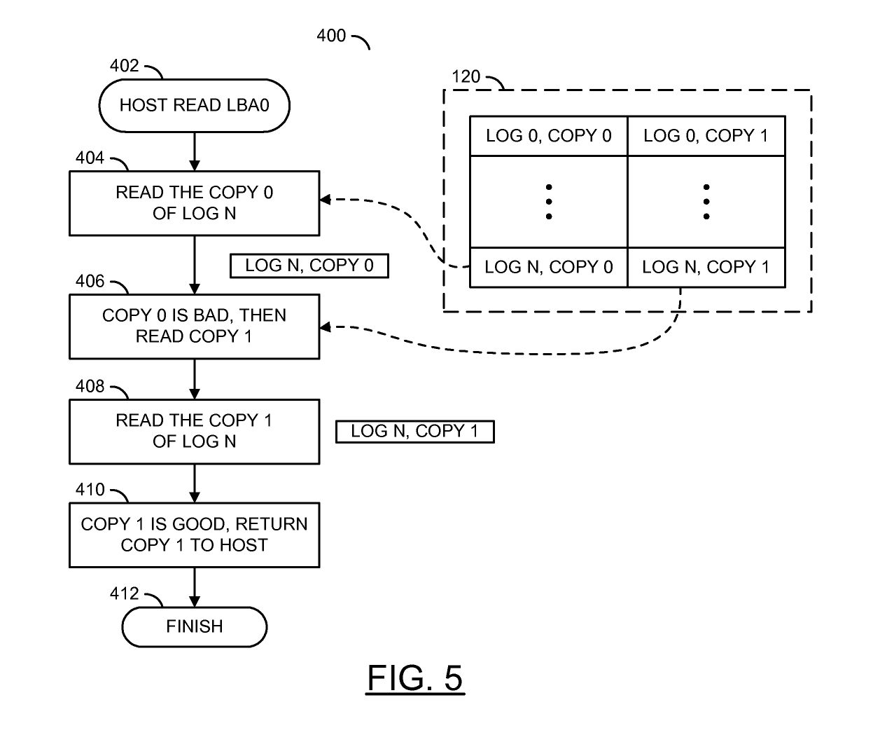

Referring to FIG. 5, a diagram of a method 400 is shown.

The method 400 may process a media failure. Instructions to execute the steps of the method 400 may be stored in the memory 90. The method 400 generally comprises a step (or state) 402, a step (or state) 404, a step (or state) 406, a step (or state) 408, a step (or state) 410, and a step (or state) 412. The state 402 may implement a host read of the LBA0. The state 404 may read a copy 0 of the Log N. Next, the state 406 may determine whether the copy 0 is bad. If the copy 0 is bad, the method 400 then reads the copy 1. Next, the state 408 reads the copy 1 of Log N. Next, the state 410 determines if the copy 1 is good (e.g., not corrupted and generally readable). If the copy is good, the method returns copy 1 to the host 60. Next, the state 412 finishes (or ends) the method 400.

In the case of a media error, dual (or redundant) copies of the MBR may be used to recover the corrupted entry. If the host 60 requests a read of LBA0, the memory 80 reads copy 0 of last entry of the log area, which is Log N. The memory 80 may find that copy 0 is bad, then reads copy 1 of Log N. The memory 80 then reads copy 1 of Log N. If the Log N is good, the memory 60 returns copy 1 of Log N to the host 60.

An old copy of the LBA0 is saved. As the host 60 presents read/write requests, the old copy of LBA0 may be restored. Restoring LBA0 may be used when a user corrupts the LBA0, or after unintended copy or when a current copy of the LBA0 is bad (or corrupt).

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The functions performed by the diagrams of FIGS. 2-5 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. A method for protecting a master boot record in a solid state drive, comprising the steps of:
receiving a plurality of input/output requests from a host device;
determining whether one or more of said input/output requests is read/written to a first of a plurality of logical block addresses of said solid state drive; and
writing an entry to a table for each of said input/output requests read/written to said first of said logical block addresses, wherein said table (i) is separate from said first of said logical block addresses and (ii) is used to recover errors in said first of said logical block addresses.

2. The method according to claim 1, wherein said first of said logical block addresses comprises a master boot record (MBR).

3. The method according to claim 1, wherein said errors and said first logical block addresses comprise media errors.

4. The method according to claim 1, wherein said errors in said first of said logical block addresses comprise unintended overwrites.

5. The method according to claim 1, wherein said table comprises a log used to restore a previous value written to said first of said logical block addresses.

6. The method according to claim 1, wherein said method is implemented in the firmware of said solid state drive.

7. The method according to claim 1, wherein said table is stored in said solid state drive.

8. The method according to claim 1, wherein said solid state drive comprises a plurality of NAND flash cells.

9. An apparatus comprising:
a memory configured to store data;
means for processing a plurality of input/output requests to read/write to/from said memory, wherein said means for processing (i) receives a plurality of input/output requests from a host device, (ii) determines whether one or more of said input/output requests is read/written to a first of a plurality of logical block addresses and (iii) writes an entry to a table for each of said input/output requests read/written to said first of said logical block addresses, wherein said table (i) is separate from said first of said logical block addresses and (ii) is used to recover errors in said first of said logical block addresses.

10. An apparatus comprising:
a memory configured to store data;
a controller configured to process a plurality of input/output requests to read/write to/from said memory, wherein said controller is configured to (i) receive a plurality of input/output requests from a host device, (ii) determine whether one or more of said input/output requests is read/written to a first of a plurality of logical block addresses and (iii) write an entry to a table for each of said input/output requests read/written to said first of said logical block addresses, wherein said table (i) is separate from said first of said logical block addresses and (ii) is used to recover errors in said first of said logical block addresses.

11. The apparatus according to claim 10, wherein said memory comprises a flash memory.

12. The apparatus according to claim 10, wherein said controller runs firmware to process said input/output requests.

13. The apparatus according to claim 10, wherein said memory comprises a plurality of NAND flash memory cells.

14. The apparatus according to claim 10, wherein said apparatus comprises a solid state drive.

15. The apparatus according to claim 10, wherein said first of said logical block addresses comprises a master boot record (MBR).
